(19) United States
(12) Patent Application Publication
(10) Pub. No.: US 2006/0214626 A1
(43) Pub. Date: Sep. 28, 2006

(54) Battery charging assembly for use on a locomotive

(76) Inventors: Lee A. Nilson, Spokane Valley, WA (US); Michael T. Abbott, Spokane Valley, WA (US); Duane G. Fricke, Spokane Valley, WA (US)

Correspondence Address: WELLS ST. JOHN P.S., 601 W. FIRST AVENUE, SUITE 1300, SPOKANE, WA, 99201, US

(21) Appl. No.: 11/090,530

(22) Filed: Mar. 25, 2005

(51) Int. Cl. H02J 7/00

(52) U.S. Cl. 320/104

(57) ABSTRACT

A battery charging assembly for use on a locomotive is described and which includes a diesel engine having a mechanical power output of less than about 50 horsepower; an oil tank coupled in fluid flowing relation relative to the diesel engine and which contains a volume of oil which facilitates the operation of the diesel engine for a time period which is at least equal to a maintenance interval of the locomotive; an alternator coupled to the mechanical output of the diesel engine and which produces an electrical power output to charge a plurality of batteries which are mounted on the locomotive; and an air compressor coupled in fluid flowing relation to the locomotives air system.

### TECHNICAL FIELD

The present invention relates to a battery charging assembly for use on a locomotive, and more specifically, to a battery charging assembly which provides an electrical power output which is operable to, on the one hand, maintain the electrical charge of batteries, which are utilized on the locomotive, and further, can be employed to energize electrical devices for remotely controlling the operation of the locomotive.

### BACKGROUND OF THE INVENTION

The prior art is replete with numerous examples of devices which employ schemes for charging the batteries which might be utilized on a locomotive. For example, in U.S. Pat. No. 6,236,185 a compressed air power supply and rechargeable battery pack is described. In this arrangement, an air powered electrical generator is utilized to recharge a battery which provides peak operating power as well as backup power for electrical devices in End of Train (EOT) arrangements if the generating system is subsequently rendered inoperable. Still further, in U.S. Pat. No. 6,308,639 a hybrid battery/gas turbine locomotive is described. A microturbine which produces as much as much as 80 kW of electrical power is utilized to charge a large number of batteries which are utilized to power the locomotive. The microturbine that is described has a charging power between 25 and 250 kW. The arrangement, as shown in this patent is adapted for use on a locomotive which is used as a switching vehicle.

Another relevant prior art reference is U.S. Pat. No. 4,087,734 to Blutreich and which relates to a charging circuit for a combination trolley and battery powered locomotive. In this U.S. Patent, there is disclosed an electrical charging circuit for charging the locomotive battery from the voltage of a trolley wire. This arrangement includes a contactor device which is provided in the circuit between the trolley wire and the battery. In the disclosed arrangement the contactor device is energized to supply direct current power from the trolley wire to the battery to permit charging of the battery to a preselected voltage level. A voltage sensing apparatus is provided in the circuit between the contactor and the battery, which monitors the voltage level of the contactor device. The battery power is provided to the locomotive, or trolley when electrical power is not available from an overhead trolley wire.

U.S. Pat. No. 6,725,134 relates to a control strategy for diesel engines and auxiliary loads to reduce emissions during engine power level changes. In this invention, a control system is provided which monitors, screens, and prioritizes the application of additional auxiliary loads, and when possible, defers the application until the load increase demanded on the engine due to the throttle position changes has been satisfied, that is, the engine has reached steady-state operation at the new load level. The prioritization scheme is based on the operating conditions of the engine, and specific auxiliary load requesting activation. In this arrangement, if operating conditions do not permit deferral of the additional auxiliary load, then the auxiliary loads are sequentially switched on and off to avoid a situation where several auxiliary loads simultaneously demand additional power from the diesel engine.

A battery charging assembly which addresses the various shortcomings attendant with the prior art devices and practices utilized heretofore is the subject matter of the present invention.

### SUMMARY OF THE INVENTION

A first aspect of the present invention relates to a battery charging assembly for use on a locomotive and which includes a diesel engine having a mechanical power output of less than about 50 horsepower; an oil tank coupled in fluid flowing relation relative to the diesel engine, and which contains a volume of oil which facilitates the operation of the diesel engine for a time period which is at least equal to a maintenance interval for the locomotive; and an alternator coupled to the mechanical output of the diesel engine, and which produces an electrical power output to charge a plurality of batteries which are mounted on the locomotive.

Another aspect of the present invention relates to a battery charging assembly for use on a locomotive and which includes an oil tank which is mounted on the locomotive and which has a top surface, and which further encloses a volume of oil; a diesel engine of less than about 50 horsepower, and which is mounted on the top surface of the oil tank, and which is further coupled in fluid flowing relation relative to the oil tank, and wherein the diesel engine, when actuated, produces a mechanical power output, and is further operable to withdraw oil from oil tank, and return the oil to the oil tank following the circulation of the oil in the diesel engine; a selectively engageable clutch which is mounted in force receiving relation relative to the mechanical power output of the diesel engine; an air compressor mounted on the top surface of the oil tank and which mechanically cooperates with the clutch, and wherein the clutch, when engaged, is operable to deliver mechanical energy from the diesel motor to actuate the air compressor, and wherein the air compressor, when actuated, provides a source of compressed air which is delivered to the locomotive; an alternator, mounted on the oil tank, and which is coupled in force receiving relation relative to the mechanical power output of the diesel engine, and wherein the alternator, when actuated by the diesel engine, provides a DC electrical power output of less than about 74 volts DC to charge a plurality of batteries which are mounted on the locomotive; and a programmable controller which is coupled in controlling relation relative to the diesel engine, and the clutch, and which further controls, at least in part, the operation of the alternator and the air compressor.

Still another aspect of the present invention relates to battery charging assembly for use on a locomotive and which includes an oil tank defined by a top and bottom surface, and a sidewall which extends between the top and bottom surfaces, and wherein the oil tank is mounted on, and disposed in spaced relation relative to, the locomotive, and wherein the oil tank defines an internal cavity having opposite first and second ends, and which receives and stores a volume of oil which is greater than about 15 gallons therein, or of a volume which will allow the diesel engine to operate for at least 92 days, and wherein an oil diffusing baffle is positioned within the cavity of the oil tank and is disposed in spaced relation relative to the top surface thereof, and wherein an aperture is formed in the top surface and which facilitates access to the cavity; a diesel engine of less than about 50 horsepower and which is mounted on the top surface of the oil tank, and which is further coupled in fluid flowing relation relative to the oil tank by way of the aperture which is formed in the top surface, and wherein the diesel engine, when actuated, has a mechanical power output, and further withdraws oil from the oil tank, and then, following circulation in the diesel engine, returns the previously withdrawn oil back into the oil tank and onto the oil diffusing baffle, and wherein the oil diffusing baffle directs the oil along a path of travel and delivers the oil to a location which is near the opposite ends of the cavity to facilitate the mixing of the oil within the cavity; a fuel line coupled to the diesel engine and having a distal end which is received within a diesel fuel tank, and which is mounted on the locomotive, and which is further positioned remotely relative to the diesel engine, and wherein the diesel engine withdraws a source of diesel fuel from the diesel fuel tank and through the fuel line for consumption; a starting battery borne by the top surface of the oil tank, and which provides an electrical current; a starting motor coupled in force transmitting relation relative to the diesel motor and which is selectively energized by the electrical current which is provided by the starting battery, and wherein the starting motor, when energized renders the diesel engine operational; a cooling radiator coupled in fluid flowing relation relative to the diesel engine, and which cools the diesel motor after the diesel engine has been started; a selectively engageable clutch which is mounted in force receiving relation relative to the mechanical power output of the diesel engine; an alternator which is coupled in force receiving relation relative to the mechanical power output of the diesel engine, and wherein the alternator, when actuated, produces an electrical power output of less than about 74 volts DC which is utilized, at least in part, to charge a plurality of batteries which are mounted on, and subsequently utilized by the locomotive, to provide electrical power for the controls and the occasional propulsion of the locomotive; a DC to DC converter which is electrically coupled to the DC electrical power output of the alternator, and which provides a charging current for maintaining the electrical charge of the starting battery; an air compressor borne by the top surface of the oil tank and which is disposed in selective force receiving relation relative to the diesel engine by the clutch, and wherein the air compressor, when actuated, provides a source of compressed air which is delivered to the locomotive and selectively utilized by the locomotive for braking and other needs; and a programmable controller which is coupled in electrical charge sensing relation relative to the plurality of batteries which are mounted on the locomotive, and further disposed in controlling relation relative to the diesel engine, the starting motor for the diesel motor, the alternator, the air compressor and the selectively engageable clutch.

These and other aspects of the present invention will be discussed in greater detail hereinafter.

### BRIEF DESCRIPTION OF THE DRAWINGS

Preferred embodiments of the invention are described below with reference to the following accompanying drawings.

FIG. 1 is a greatly simplified depiction of the present invention as it would be deployed and utilized on a remotely controlled locomotive which is operably coupled with a second locomotive.

FIG. 2 is a perspective, side elevation view of an oil tank which is utilized with the present invention.

FIG. 3 is a perspective, exploded, side elevation view of the oil tank of FIG. 2.

FIG. 4 is a perspective, side elevation view of the battery charging assembly of the present invention.

FIG. 5 is a perspective, exploded view of an oil delivery tube which is utilized with the present invention.

FIG. 6 is a plan view taken through an aperture which is defined by the oil tank as seen in FIG. 2.

FIG. 7 is a perspective view of a control assembly including a programmable controller which is utilized with the present invention.

FIG. 8 is a side elevation view of a vibration isolating assembly which is utilized with the present invention.

FIG. 9 is a fragmentary view of a fuel line which is employed with the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

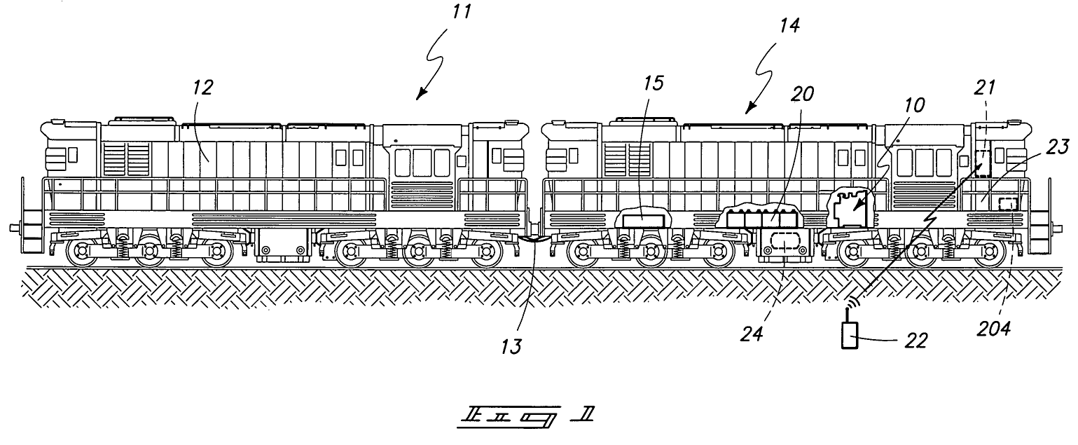

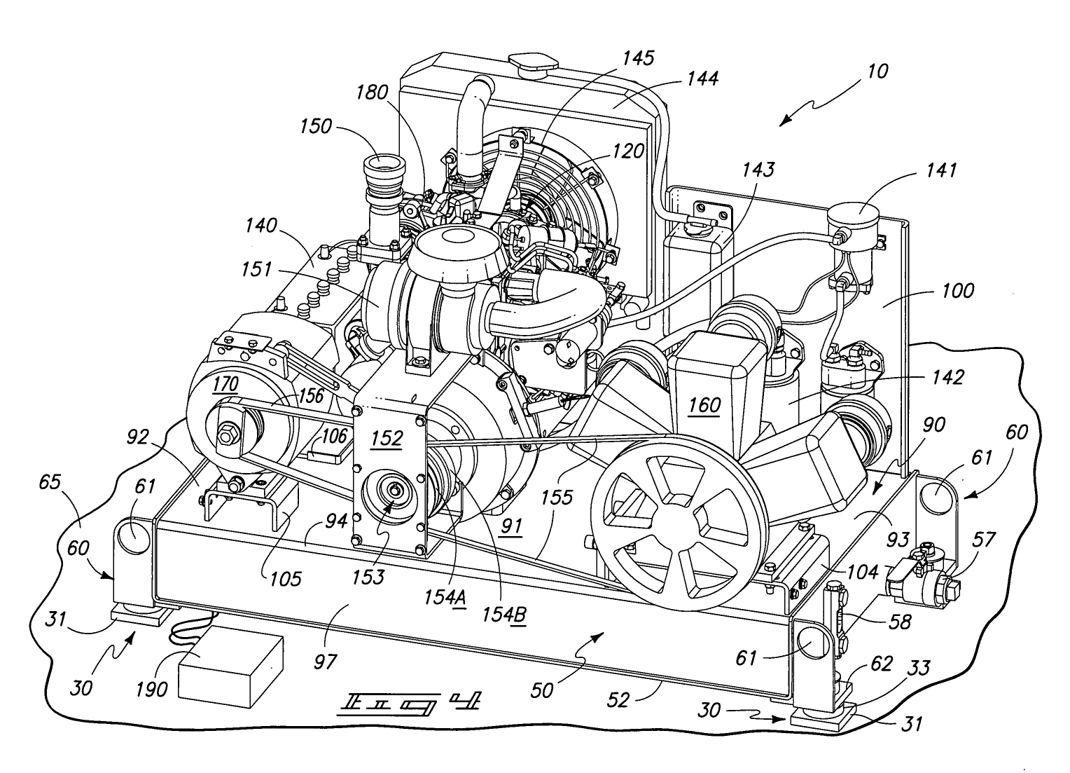

A battery charging assembly for use on a locomotive is generally indicated by the numeral 10 in FIG. 1 and 4 respectively. As seen in FIG. 1, a first diesel powered locomotive 11 of conventional design is illustrated. A diesel engine 12 which is provided on the locomotive 11 is operable to drive an electrical generating system (not shown) and which, in turn, supplies electrical current to a plurality of direct current, or alternating current traction motors having rotors which are drivingly coupled, through speed reducing gearing, to axle-wheel sets of the locomotive. In the arrangement as shown, the locomotive 12 is coupled through a controlling coupler 13 to a remotely controlled locomotive 14 and which is mechanically coupled thereto. This controlling coupler 13 is familiar to those who are skilled in the art, and allows the diesel locomotive 11 to be controlled by way of the remotely controlled locomotive 14. The remotely controlled locomotive 14 includes, among other things, at least one traction motor 15 which supplies a mechanical output which drives the wheels of the locomotive when the locomotive 14 is occasionally detached from the locomotive 11. The locomotive 14 does not have a large horse power diesel motor mounted thereon and which would typically drive the locomotive 14. However, in those instances where the remotely controlled locomotive 14 is separated from the diesel locomotive 11 as might be occasioned when the diesel locomotive 11 has become disabled, the traction motor 15 is supplied with electrical power to drive the locomotive 14 by way of a plurality of batteries 20 which are positioned or mounted on the remotely controlled locomotive 14. In the arrangement as seen in FIG. 1, the remotely controlled locomotive 14 has mounted thereon an electrically actuated control assembly 21 which is operated remotely by a wireless control 22. By means of the wireless control, a remote operator can operate the diesel locomotive 11 and the remotely controlled locomotive 14 and utilize same to switch railroad cars, and do other tasks without the need for a locomotive engineer being present. The remotely controlled locomotive further has an air brake compartment 23 having conventional air brake components. As should be understood, the remotely controlled locomotive 14 when separated from the diesel powered locomotive, and being propelled by the traction motor 15, uses compressed air for braking the locomotive while it is traveling alone and other purposes. Otherwise, when controllably coupled to the diesel locomotive 11, the diesel locomotive 11 typically provides compressed air for braking to the locomotive 14. The remotely controlled locomotive 14 further has a diesel fuel tank 24 which encloses a source of diesel fuel.

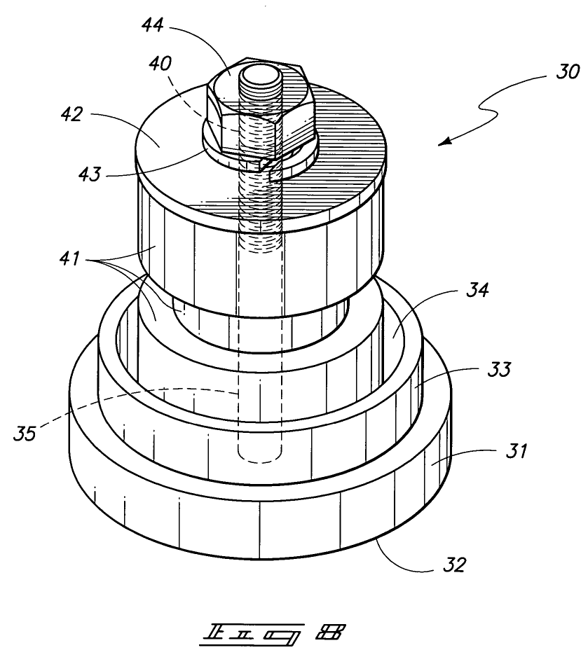

Referring now to FIG. 8, the battery charging assembly for use on a locomotive 10 of the present invention is mounted in spaced relationship relative to a supporting surface of the remotely controlled locomotive 14 by way of a plurality of vibration isolating mounting fixtures, one of which is seen in FIG. 8. The vibration isolating mounting fixtures 30 include a base plate 31, which is affixed by welding, to an underlying supporting surface. The base plate 31 which is typically fabricated from steel, or the like, has a bottom surface 32 which rests in juxtaposed relation relative to an underlying supporting surface. Further, the base plate includes opposite top surface which has attached thereto a circumscribing upwardly extending wall 33. An internal cavity 34 is defined by the circumscribing wall. Still further, a shaft 35 is affixed at one end to the base plate 31 and extends normally upwardly relative thereto and terminates in a threaded end portion 40. As seen in FIG. 8, a plurality of substantially annularly shaped synthetic, and resilient members 41 are received about the shaft 35. Still further, a metal washer 42 is received about the shaft 35 and is operable to retain the plurality of resilient members 41 thereon. A lock washer 43 is operable to engage the metal washer 42, and further, a nut 44 of conventional design is operable to threadably mate with the threaded end portion 40 thereby capturing the plurality of resilient members 41 on the shaft 35. The vibration isolating mounting fixture is operable to minimize the amount of vibration which is transmitted between the remotely controlled locomotive 14, and the battery charging assembly 10.

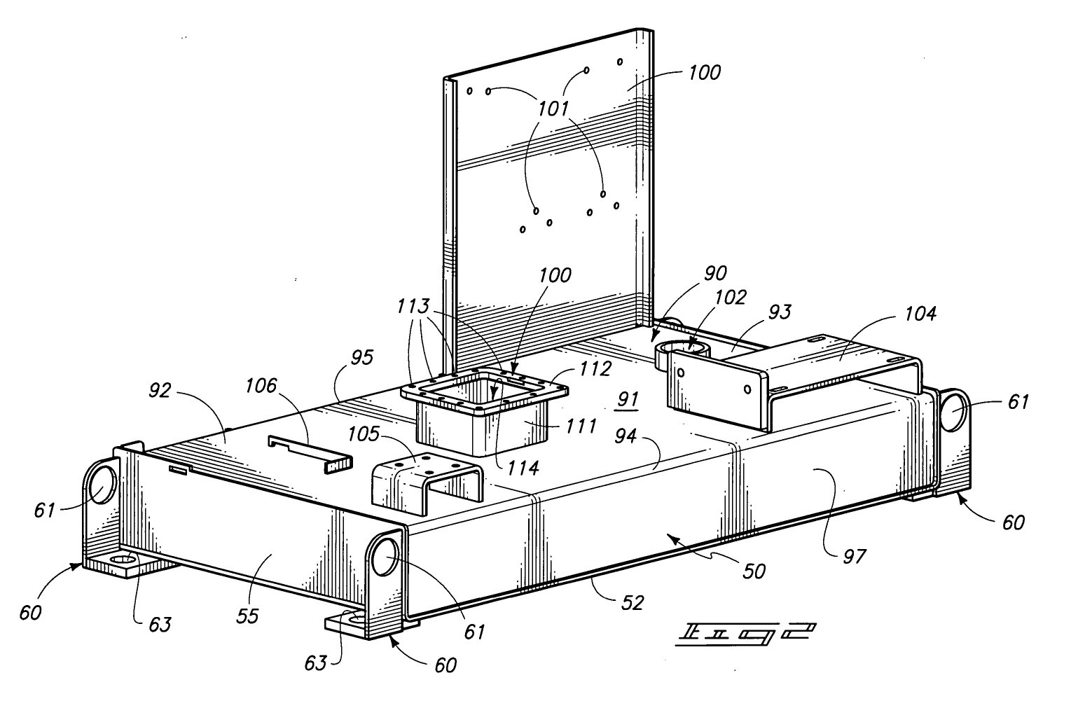

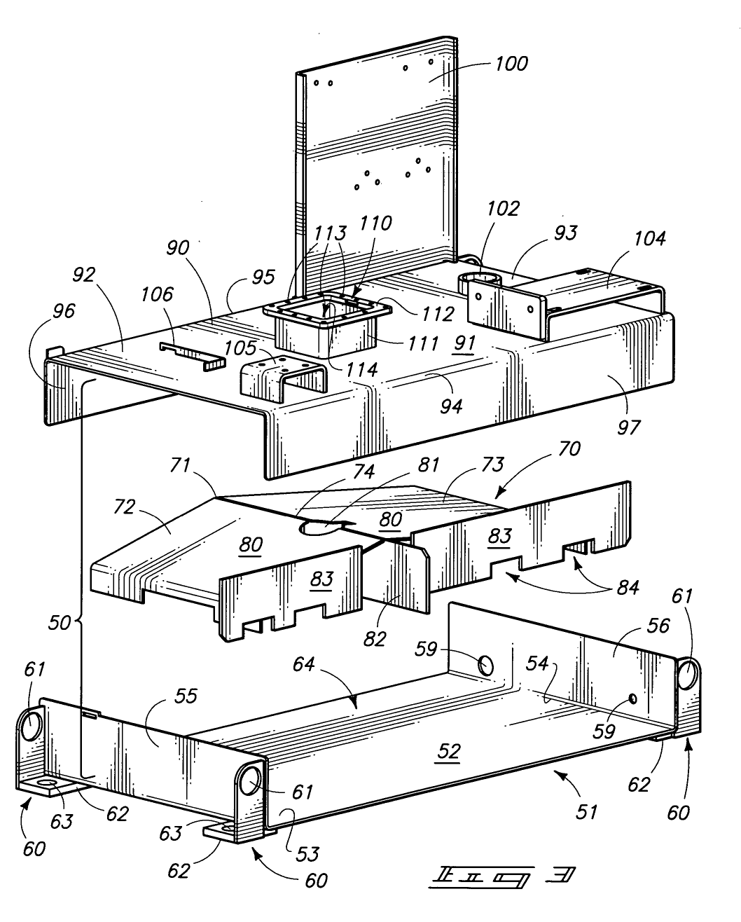

Referring now to FIGS. 2 and 3, the battery charging assembly for use in a locomotive 10 includes an oil tank 50 which encloses a volume of oil which is utilized in the battery charging assembly 10. The volume of oil selected would be at least equal to the amount needed to run the battery charger during the maintenance interval for the remotely controlled locomotive 14. This amount of oil would be generally greater than about 15 gallons. The relatively large oil tank was selected to allow the present battery charging assembly 10 to be versatile, and to minimize maintenance of the battery charging assembly to only those occasions when the remotely controlled locomotive may be being serviced for other reasons. The oil tank 50, as seen in FIG. 3 has a base portion which is generally indicated by the numeral 51. The base portion is defined by a bottom wall 52 which has a first end 53 and an opposite second end 54. Extending substantially normally upwardly relative to the first and second ends is a first end wall 55 and a second end wall 56.

As seen most clearly in FIG. 4 a conventional oil drain valve 57 is mounted on the second end wall 56 and facilitates the draining of oil from the oil tank 50. Still further, a conventional oil-sight level gauge 58 is mounted on the second end wall 56 and facilitates an operator's determination of the amount of oil that is in the oil tank. As seen in FIG. 3, suitable apertures 59 are formed in the second end wall so as to couple the oil drain valve and oil-sight level gauge in fluid flowing relation relative to the oil tank.

As seen in FIG. 3, lifting fixtures 60 are mounted to the opposite ends of each of the first and second end walls 55 and 56, respectively. Each lifting fixture 60 has an aperture 61 formed therein, and which facilitates the attachment of a suitable lifting device in order to facilitate the movement of the present battery charging assembly 10 using conventional lifting devices, and place it in an appropriate position within the remotely controlled locomotive 14. Still further, and as seen in FIG. 3, mounting plates 62 are individually affixed to both the individual lifting fixtures 60, and to the bottom wall 52. Each of these mounting plates have an aperture 63 formed therein, and which are operable to receive the threaded end portion 40 of the shaft 35 and a portion of the resilient and synthetic members 41 previously described, and which forms a portion of the vibration isolating mounting fixture 30 as seen in FIG. 8. As will be understood, therefore, at least four vibration isolating mounting fixtures 30 are individually mounted in the respective corners of the base portion 51 thereby securing the bottom wall 52 in spaced relation relative to an underlying supporting surface 65 of the remotely controlled locomotive 14.

Referring now to FIG. 3, it should be understood that the oil tank 50 defines an internal cavity 64 which contains the volume of oil necessary for the battery charging assembly 10 to effectively operate between maintenance cycles of the remotely controlled locomotive 14. Positioned within the internal cavity 64 is an oil diffusing baffle 70 which is operable to facilitate the mixing of the oil which is enclosed within the internal cavity 64. In this regard, the oil diffusing baffle 70 has a main body 71 which has a first sloped portion 72, and a second sloped portion 73. As illustrated in FIG. 3, the first and second sloped portions are joined at an apex 74. Each of the first and second sloped portions have a top surface 80. Yet further, an aperture 81 is formed in each of the top surfaces of the first and second sloped portions 72 and 73 and is positioned at substantially the apex thereof. As illustrated in FIG. 3, a transversely disposed support member 82 is positioned therebelow the first and second sloped portions 72 and 73 and is operable to support same as well as being disposed in rested relation on the bottom wall 52. Yet further, it will be seen in FIG. 3 that a pair of longitudinally disposed support members 83 are individually affixed to each of the first and second sloped portions 72 and 73. These respective support members 83 are utilized to direct oil which is being delivered back into the oil tank 50 along a course of travel where the oil travels along the top surface 80 of the individual first and second sloped portions, and is thereafter deposited at a location near the first and second ends 53 and 54, respectively of the bottom wall 52. As seen the exploded view of FIG. 3, the oil diffusing baffle defines a number of oil passageways 84 which are formed therein and which facilitate the movement of the oil throughout the oil tank 50 and result in the efficient mixing thereof.

Referring still to FIG. 3, the oil tank 50, which is utilized with the present invention, has a top portion generally indicated by the numeral 90. The top portion includes an upwardly facing surface 91 which has a first end 92, and an opposite second end 93.. Still further, the upwardly facing surface 91 has opposite peripheral edges 94 and 95, respectively. Affixed to and depending substantially normally downwardly relative to the opposite peripheral edges 94 are individual first and second sidewalls 96 and 97 respectively. These opposite sidewalls are operable to be received therebetween the first and second end walls 55 and 56, and are further secured thereto by means of welding and the like to make a substantially fluid impervious container. As seen by reference to FIG. 3, the oil diffusing baffle 90 is positioned therebetween the first and second sidewalls 96 and 97 and in the internal cavity 64 of the oil tank 50.

Referring now to FIGS. 2 and 3, it will be seen that a support member 100 extends substantially normally upwardly relative to the upwardly facing surface 91 and is positioned adjacent to one of the peripheral edges 95. The support member has a plurality of apertures 101 formed therein and various components of the battery charging assembly 10 of the present invention are mounted thereto, and which will be discussed in greater detail hereinafter. Closely adjacent to the second end 93 of the upwardly facing surface 91 is an oil filling aperture 102. As will be discussed below, the oil filling aperture allows a given volume of oil to be received in the oil tank 50 when the battery charging assembly 10 of the present invention is operational. Mounted adjacent to the oil filling aperture 102 is a compressor mount 104. The compressor mount is affixed by welding, and the like, to the upwardly facing surface 91, and is positioned near the second end 93. Positioned near the first end 92 of the upwardly facing surface, and positioned adjacent one of the peripheral edges 95 is an alternator mount 105. Still further, a battery mount 106, of conventional design, is affixed near the second end 93 and is adjacent to the alternator mount 105.

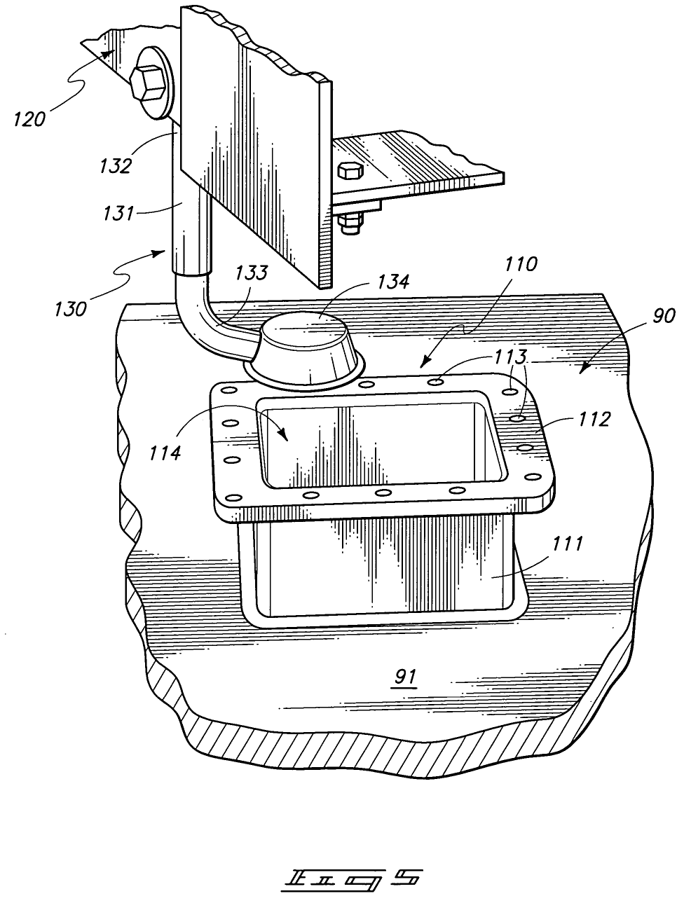

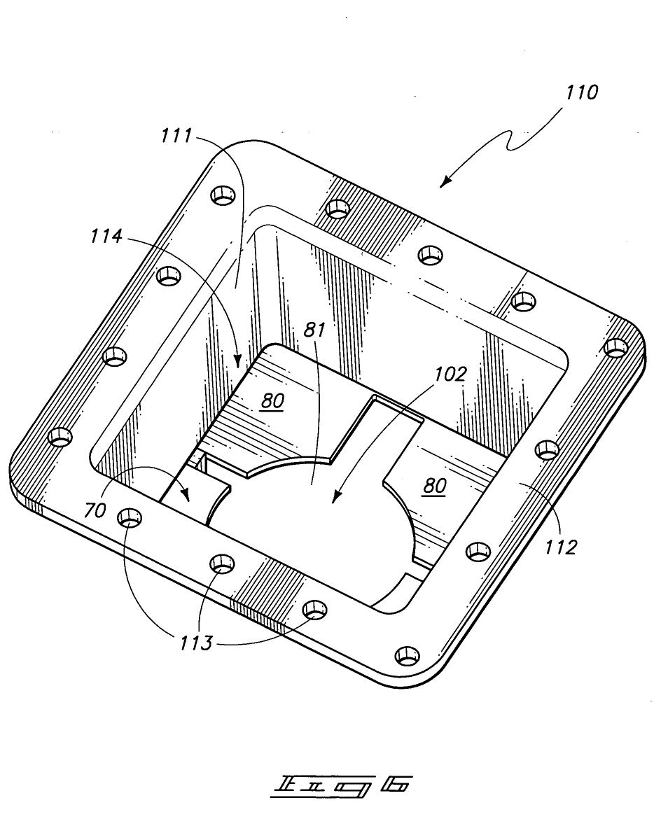

Positioned generally centrally relative to the upwardly facing surface 91 is an engine mount 110. The engine mount is defined by an upwardly extending sidewall 111 which is affixed by welding and the like to the upwardly facing surface 91. A mounting flange 112 is affixed by welding to the upwardly extending sidewall 111 and has a plurality of apertures 113 formed therein as seen most clearly by reference to FIG. 5. As best illustrated by reference to FIG. 6, the engine mount 110 defines a passageway 114 which allows fluid communication between the oil tank 50, and the oil received in same, and a diesel engine, which will be discussed below, and which is affixed to the engine mount 110. As illustrated in FIG. 6, it will be seen that the oil diffusing baffle 70 is positioned in spaced relation relative to the top portion 90 thereby allowing oil to travel along the top surface 80 thereof.

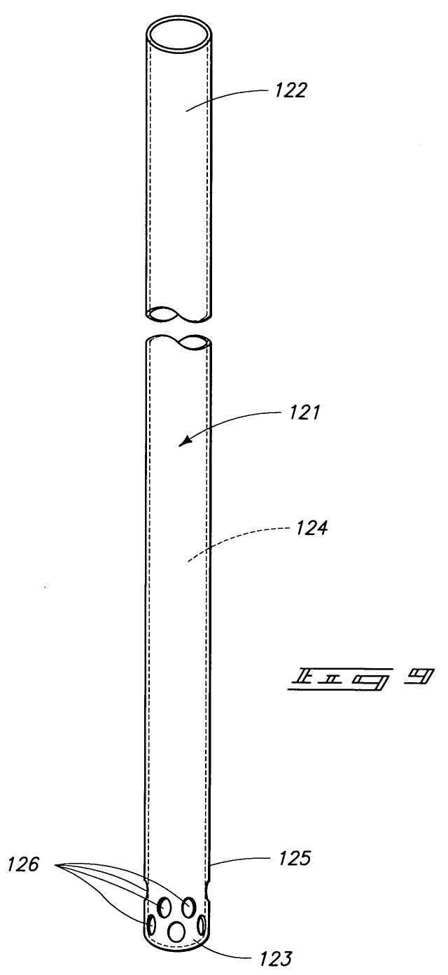

Referring now to FIG. 4, it will be seen that the battery charging assembly 10 of the present invention includes a diesel engine 120 of conventional design and which has a mechanical power output of less than about 50 horsepower. As shown herein, the diesel motor which is depicted has a mechanical power output of less than about 20 horsepower. The diesel engine 120 is mounted onto the engine mount 110 using conventional fasteners which pass through the apertures 113 which are formed in the mounting flange 112. The diesel engine 120 is supplied with diesel fuel from the diesel fuel tank 24 which is positioned on the remotely controlled locomotive 14 as seen in FIG. 1 by a fuel line 121 as seen in the fragmentary view of FIG. 9. The fuel line has a first end 122 which is fluidly coupled to the diesel engine 120, and an opposite, second end 123 as seen in FIG. 9 and which is submerged in the diesel fuel. A fuel passageway 124 is defined between the first and second ends 122 and 123 respectively. The second end of the fuel line 123 is received in the remotely positioned diesel fuel tank. Still further and as seen in FIG. 9, the distal end of the fuel line is defined by a sidewall 125 which has a plurality of apertures 126 formed therein. These plurality of apertures prevent the fuel line from becoming obstructed by debris which might be found in the diesel fuel tank 24. The diesel engine 120 which is mounted to the top surface of the oil tank 50 is further coupled in fluid flowing relation relative to the oil tank 50 by way of an oil line which is generally indicated by the numeral 130 and which is best seen in FIG. 5. It should be understood that the diesel engine 120, when actuated, has a mechanical power output and further withdraws oil from the oil tank 50 and then following circulation of the diesel engine returns the previously withdrawn oil back into the oil tank and onto the oil diffusing baffle 70. The oil diffusing baffle is operable as earlier disclosed to direct the oil along a path to travel and deliver the oil to a location which is near the opposite ends of the cavity 64 to facilitate the mixing of the oil within the cavity. The oil line as seen in FIG. 5 has a conduit portion 131 with a first end 132 which is coupled in fluid flowing relation relative to the diesel engine 120, and a remote second end 133 which is received within the oil tank. An oil withdrawing portion 134 is mounted to the second end and is disposed in spaced relation to the bottom wall 52 of the oil tank 50.

As seen by reference to FIG. 4, a 12 volt starting battery 140 is fixedly positioned on the battery mount 106, and is secured thereto. The battery 140 is electrically coupled to a starter motor (not shown) and which is mounted on the diesel engine 120. The starting battery which is borne by the top surface 91 of the oil tank 50 provides electrical current to the starter motor, not shown, in order to start the diesel engine. It should be understood that the starter motor is coupled in force transmitting relation relative to the diesel motor 120 and is selectively energized by the electrical current which is provided by the starting battery to render the diesel engine 120 operational. Mounted on the support member 100 using conventional fasteners is an electric fuel pump 141. The electric fuel pump is coupled in fluid flowing relation relative to the first end 122 of the fuel line 121. The electric fuel pump, when energized, removes diesel fuel from the diesel fuel tank 24 and delivers it to the diesel engine 120 for consumption. Further, and mounted on the same support member 100 is an oil filter 142. The oil filter is coupled in fluid flowing relation relative to the first end 132 of the conduit portion 131 of the oil line 130. The oil filter is of conventional design and is operable to remove debris from the oil which is being withdrawn from the oil tank 50. Further, mounted on the same support member 100 is a coolant overflow reservoir 143 which is coupled in fluid flowing relation relative to a conventional cooling radiator 144. The conventional cooling radiator is coupled in fluid flowing relation relative to the diesel engine 120, and is operable to maintain the temperature of the diesel engine within given temperature parameters while it is in operation. As seen in FIG. 4, a fan 145 is mounted adjacent to the radiator 144, and is operable to urge a stream of air through the cooling radiator in order to remove heat energy therefrom. In some arrangements of the invention, this heat energy which is removed by the air stream provided by the fan can be directed into adjacent regions of the locomotive 14 in order to keep critical equipment at operational temperatures during winter or low temperature operation.

The diesel engine 120, once energized, is operable to consume diesel fuel removed from the diesel fuel tank 24 and produces exhaust which exits an exhaust manifold 150 which is mounted on the diesel engine. The exhaust exiting the exhaust manifold travels through an approved spark arresting muffler, not shown, and which is then released to the ambient environment. Still further, while operational, air which is used in the diesel engine 120 enters the engine by means of an air filter 151 which is mounted in fluid flowing relation relative to the diesel engine. As seen, in FIG. 4, the battery charging assembly 10 includes a clutch housing which is generally indicated by the numeral 152. The clutch housing is mounted on the upwardly facing surface 91 of the oil tank 50, and the air filter 151 is mounted on the top surface thereof. The clutch housing 152 mounts an electrically actuated clutch 153 of traditional design. The electrically actuated clutch 153 is mounted in force receiving relation relative to the mechanical power output provided by the diesel engine 120. The electrically actuated clutch 153 selectively rotates one pulley 154A. A second pulley 154B is provided and is directly coupled in force receiving relation relative to the diesel engine 120. As seen, in the drawing, a first belt 155 and a second 156 are received about the pair of pulleys 154 A and B and are operable to transmit mechanical power from the electrically actuated clutch 153 or the diesel engine 120 to an air compressor 160, and/or an alternator 170 as the case maybe.

It should be understood that the alternator 170 is coupled in force receiving relation relative to the mechanical output of the diesel engine 120, and wherein the alternator when electrically actuated, produces an electrical power output of less than about 74 volts DC and which is utilized, at least in part, to charge the plurality of batteries 20 which are mounted on, and subsequently utilized by the remotely controlled locomotive 14 to provide electrical power for propulsion of the locomotive by means of the traction motor 15. As illustrated the electrically actuated clutch 153 is selectively engageable to provide mechanical power to the air compressor 160. As also seen in the drawing, the air compressor is borne by the top surface of the oil tank 50, and is disposed in selective force receiving relation to the diesel engine 120 by the electrically actuated clutch 153. The air compressor, when actuated by the diesel motor provides a source of compressed air which is delivered to the remotely controllable locomotive 14. This compressed air is selectively utilized by the same locomotive for braking and other purposes. As seen in the drawings, the mechanical energy of the diesel engine 120 is transmitted to the respective air compressor and alternator 160 and 170 by means of the first and second belts 155 and 156 respectively. As seen in FIG. 4, a second alternator 180 is mounted in spaced relation relative to the upwardly facing surface 91 of the diesel engine 120. The second alternator is also mechanically coupled with the mechanical output of the diesel engine 120 and is operable to provide a 12 volt DC charging current which is delivered to the starting battery 140. This maintains the charge of the starting battery 140 so that the diesel engine 120 can be readily started when the charge on the plurality of batteries 20, which are mounted on the remotely controlled locomotive 14 are below a charge of about 65 volts DC. Additionally, and as seen in FIG. 4, a DC to DC converter 190 is provided. The DC to DC converter is electrically coupled to the DC electrical power output of the alternator 170. The DC to DC converter provides a second, alternative charging current of approximately 12 volt DC for maintaining the electrical charge of the starting battery 140 similar to that described above with respect to the second alternator.

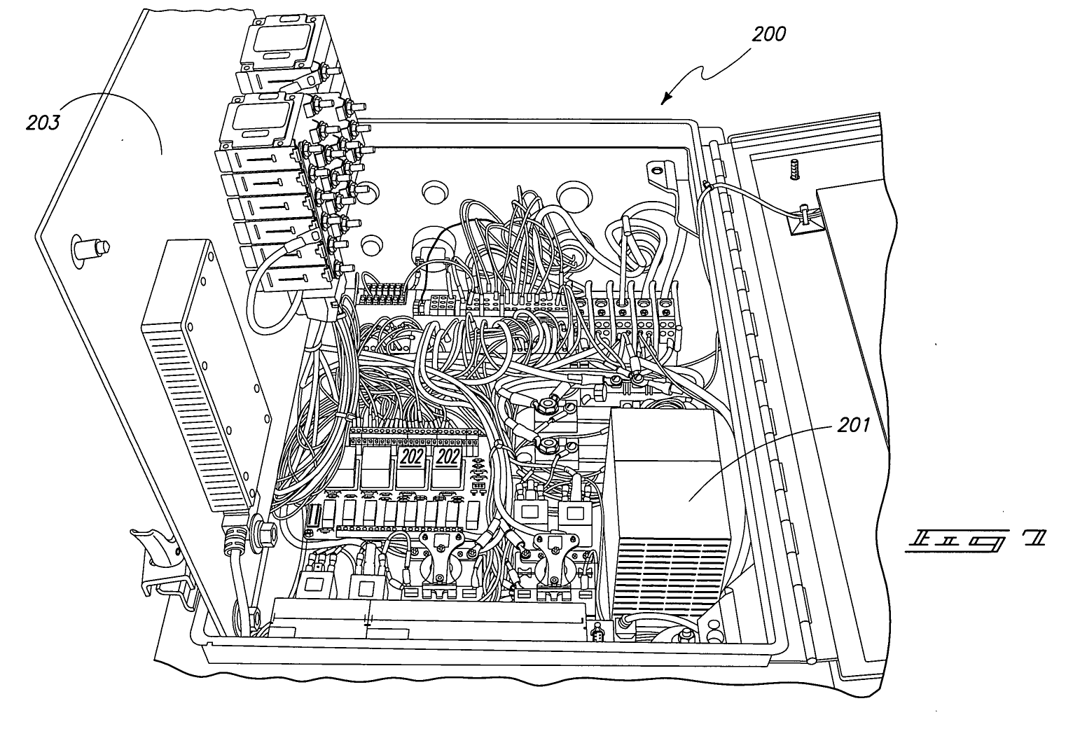

Referring now to FIG. 7, the battery charging assembly 10 of the present invention includes a programmable controller which is generally indicated by the numeral 200, and which is coupled in controlling relation relative to each of the diesel motor 120, electrically actuated clutch 153, alternator 170, and air compressor 160; and further is coupled in electrical charge sensing relation relative to the plurality of batteries 20 which are mounted on the remotely controlled locomotive 14. The programmable controller further is also electrically coupled with the electrically actuated control assembly 21 which is also borne by the remotely controlled locomotive 14 as seen in FIG. 1. As seen in FIG. 7, however, the programmable controller 200 is enclosed within a housing which includes a power supply 201 and which provides power for the programmable controller. Still further, the programmable controller is electrically coupled with a plurality of relays 202 and further includes a control panel 203 which can be selectively adjusted to various settings. The programmable controller 200, in addition to the foregoing, is also coupled in controlling relation relative to the starter motor, and which is operable to start the diesel engine 120, when energized. In the arrangement, as shown, the programmable controller 200 is coupled in controlling relation relative to the diesel engine 120 so as to control the engine speed of same. In this regard, the diesel engine 120 has at least two engine speeds, and the programmable controller 200 causes the diesel motor to start the diesel engine and operate the diesel engine at a first higher engine speed when the electrical charge of the plurality of batteries 20 which are mounted on the locomotive 14 have a charge of less than about 65 volts DC or while the charging current provided to the plurality of batteries 20 is greater than about 30 Amps. Further, the programmable controller is operable to operate the diesel engine at a second lower engine speed when the electrical charging current provided to the plurality of batteries which are mounted on the locomotive 14 is less than about 30 Amps. As seen in FIG. 1 an electrical heater 204 is provided, and which is mounted on the locomotive 14 in a remote position relative to the battery charging assembly 10. The electrical heater 204 is energized by the electrical power output of the battery charging assembly 10 to alternatively provide heat for an adjacent space in the locomotive to keep electrical equipment at an operational temperature, and/or provide a load to ensure the correct operation of the electrical charging assembly, and more specifically the diesel engine 120 during periods of light alternator load. In the arrangement as seen, the battery charging assembly 10 of the present invention weighs less than about 1300 lbs. and occupies a space of less than about 35 cubic feet. The oil tank 50 as provided herewith has an oil capacity of greater than about 15 gallons, however, the tank capacity is chosen such that the volume of oil which is contained within the oil tank facilitates the operation of the diesel engine 120 for a time period which is at least equal to the maintenance interval of the locomotive 14. Typically, this time period or maintenance interval is at least equal to or greater than about 92 days. In the arrangement as illustrated the programmable controller 200 is operable to selectively energize the air compressor 160 to provide compressed air for braking the locomotive 14 when the remotely controlled locomotive is operating independently of another diesel locomotive such as 11. In the arrangement as shown, the battery charging assembly provides a convenient means to maintain the plurality of batteries 20 in a fully charged state and further produces a minimal amount of exhaust, pollution and/or noise in relative comparison to other arrangements which have been provided heretofore.

### Operation

The operation of the described embodiment of the present invention is believed to be readily apparent and is briefly summarized at this point.

As seen in the attached drawings, a battery charging assembly 10 for use on a locomotive 14 includes a diesel engine 120 having a mechanical output of less than about 50 horsepower; an oil tank 50 is coupled in fluid flowing relation relative to the diesel engine 120 and which contains a volume of oil which facilitates the operation of the diesel engine for a time period which is at least equal to the maintenance interval for the locomotive. Still further, the battery charging assembly 10 includes an alternator 170 which is coupled to the mechanical output of the diesel engine and which produces an electrical power output to charge a plurality of batteries 20 which are mounted on the locomotive 14. In the arrangement as shown the locomotive is a remotely controlled locomotive 14 which is propelled across the face of the earth by an electrically actuated traction motor 15. The locomotive 14 is operably controlled by an electrically actuated control assembly 21 which is mounted on the remotely controlled locomotive. The remotely controlled locomotive is controlled by means of a wireless control 22. The plurality of batteries 20 provide a DC power output which is supplied to and subsequently energizes the traction motor 15 so as to drive the remotely controlled locomotive across from time-to-time as needed across the face of the earth, and further energizes the electrically actuated control assembly 21. The electrical power output of the alternator 170 is selectively and alternatively supplied to the electrically actuated control assembly or the plurality of batteries when the remotely controlled locomotive 14 is operating independently of another locomotive 11.

As seen in the drawings, the battery charging assembly 10 further includes a selectively engageable clutch 153 which is disposed in force receiving relation relative to the mechanical power output of the diesel engine 120, and an air compressor 160 mechanically cooperates with the clutch and is selectively mechanically coupled to the diesel motor by way of the clutch. The air compressor 160, when actuated by the diesel engine, delivers a source of compressed air to the remotely controlled locomotive 14 for use in braking and assorted other purposes when it is being propelled across the face of the earth. In the arrangement as seen in the drawings, a cooling radiator 144 is provided and is coupled in fluid flowing relation relative to the diesel engine 120 and which further radiates heat energy. Still further, an air movement assembly such as a fan 145 is positioned adjacent to the cooling radiator and which provides a stream of cooling air to the cooling radiator. This stream of cooling air is heated by the cooling radiator and is supplied to the locomotive so as to heat adjacent spaces and keep critical equipment at an operational temperature.

A battery charging assembly 10 for use on a locomotive 14 is shown and described and which includes an oil tank 50 which is mounted on the locomotive 14 and which has a top surface 91 and which further encloses a volume of oil 50. A diesel engine of 120 of less than about 50 horsepower is provided and which is mounted on the top surface of oil tank 50 and which is further coupled in fluid flowing relation relative to the oil tank 50. The diesel engine, when actuated produces a mechanical power output and is further operable to withdraw oil from the oil tank 50 and return the oil to the oil tank following the circulation of the oil in the diesel engine 120. The invention further includes a selectively engageable clutch 153 which is mounted in force receiving relation relative to the mechanical power output of the diesel engine 120. As seen in FIG. 4, an air compressor 160 is provided and mounted on the top surface 91 of the oil tank 50 and which mechanically cooperates with the clutch 153. The clutch, when engaged is operable to deliver mechanical energy from the diesel engine to actuate the air compressor, and which provides a source of compressed air which is delivered to the locomotive and which is typically utilized for braking and other purposes. As seen in the drawings, an alternator 170 is provided and mounted on the diesel engine and which is coupled in force receiving relation relative to the mechanical power output of the diesel engine 120. The alternator 170 when actuated by the diesel engine provides a DC electrical power output of less than about 74 volts DC to charge a plurality of batteries 20 which are mounted on the locomotive 14. As seen in FIG. 7, a programmable controller 200 is provided and which is coupled in controlling relation relative to the diesel engine 120, clutch 153, alternator 170, and air compressor 160. As earlier discussed, the volume of oil enclosed within the oil tank 50 is greater than about 15 gallons. The oil tank defines an internal cavity 64 which has opposite first and second ends and further encloses an oil diffusing baffle 70. The oil diffusing baffle is operable to direct oil which is being returned to the oil tank 50 by the diesel engine 120 along a path of travel so that the returned oil is delivered into the cavity 64 at the first and second ends thereof. As seen in the drawings, the vibration isolating mounting fixtures 30 are provided and which are mounted on the locomotive 14 and which positions the oil tank 50 in spaced relation relative to the locomotive.

The battery charging assembly 10 for use in a locomotive 14 has a size and weight which provides great versatility and reduced emissions to the environment. In the arrangement as shown the programmable controller 200 controls operation of the battery charging assembly 10, and is further in charge sensing relation relative to the plurality of batteries 20 which are provided on the remotely controlled locomotive 14. The programmable controller 200 upon sensing an electrical charge of less than about 65 volts DC for the plurality of batteries 20 causes the starting motor to become energized by the starting battery 140. The starting battery 140 starts the diesel engine 120 and the diesel engine, once started causes the alternator 170 to deliver a DC electrical power output of less than about 74 volts DC to increase the electrical charge of the plurality of batteries. Still further, upon further sensing a charging current being provided to the plurality of batteries which is less than about 30 Amps, the programmable controller is operable to significantly slow the delivery of the DC electrical power output of the alternator to the plurality of batteries. In the invention as shown an electrically actuated heater 204 is provided and which is borne by the locomotive 14 and is selectively electrically coupled with a DC electrical power output of the diesel engine. The electrical heater is provided to increase the electrical load of the alternator and improve the performance of the diesel engine 120. The programmable controller 200 is operable to control both the speed of operation of the diesel engine motor 120 based at least in part on the electrical charge of the plurality of batteries as sensed by the programmable controller and the further requirements of the locomotive 14. In the arrangement as shown, the remotely controlled locomotive 14 is controlled by means of an electrically actuated control assembly 21 and the plurality of batteries 20 are utilized in propelling the remotely controlled locomotive 14 when it is operating independently of the diesel locomotive 11. The programmable controller 200 causes the DC electrical power output of the alternator to be delivered to the electrically actuated control assembly 21 when electrical power is being delivered from the plurality of batteries 20 to propel the remotely controlled locomotive 14. The programmable controller 200 substantially deactivates the alternator 170 when the air compressor 160 is selectively activated to provide a source of compressed air which is selectively utilized for braking the remotely controlled locomotive.

Therefore, it will be seen that the battery charging assembly for use on a locomotive of the present invention provides many advantages and reduces noxious emissions and noise to the environment in a fashion not possible heretofore. The present assembly is compact, relatively lightweight in comparison to other assemblies utilized heretofore, and provides a convenient means for maintaining the electrical charge of batteries which are used in remotely controlled locomotives of the present design.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I/We claim:

1. A battery charging assembly for use on a locomotive, comprising:
a diesel engine having a mechanical power output of less than about 50 horsepower;
an oil tank coupled in fluid flowing relation relative to the diesel engine and which contains a volume of oil which facilitates the operation of the diesel engine for a time period which is at least equal to a maintenance interval for the locomotive; and
an alternator coupled to the mechanical output of the diesel engine, and which produces an electrical power output to charge a plurality of batteries which are mounted on the locomotive.

2. A battery charging assembly as claimed in claim 1, and wherein the locomotive is a remotely controlled locomotive which is propelled across the face of the earth by an electrically actuated traction motor, and further is operably controlled by an electrically actuated control assembly which is mounted on the remotely controlled locomotive, and wherein the plurality of batteries mounted on the locomotive provide a DC power output which is supplied to, and subsequently energizes the traction motor so as to drive the remotely controlled locomotive across the face of the earth, and further energizes the electrically actuated control assembly, and wherein the electrical power output of the alternator is selectively alternatively supplied to the electrically actuated control assembly or the plurality of batteries.

3. A battery charging assembly as claimed in claim 2, and further comprising:
a selectively engageable clutch which is disposed in force receiving relation relative to the mechanical power output of the diesel engine; and
an air compressor which mechanically cooperates with the clutch, and which is selectively mechanically coupled to the diesel engine by the clutch, and wherein the air compressor, when actuated by the diesel engine, delivers a source of compressed air to the remotely controlled locomotive for use in braking the remotely controlled locomotive when it is being propelled across the face of the earth.

4. A battery charging assembly as claimed in claim 3, and further comprising:
a programmable controller which is coupled in controlling relation relative to each of the diesel motor, and clutch; and wherein the programmable controller is further coupled in electrical charge sensing relation relative to the plurality of batteries which are mounted on the remotely controlled locomotive, and is also electrically coupled with the electrically actuated control assembly.

5. A battery charging assembly as claimed in claim 1, and wherein the oil tank has an oil storage capacity of greater than about 15 gallons of oil.

6. A battery charging assembly as claimed in claim 1, and wherein the time period which is at least equal to the maintenance interval of the locomotive is greater than about 92 days.

7. A battery charging assembly as claimed in claim 1, and further comprising:
a source of diesel fuel borne by the locomotive; and
a fuel line coupling the source of diesel fuel to the diesel engine.

8. A battery charging assembly as claimed in claim 1, and wherein the oil tank has a top and a bottom surface, and wherein the bottom surface of the tank is mounted on the locomotive, and wherein the diesel engine is mounted on the top surface of the oil tank.

9. A battery charging assembly as claimed in claim 8, and wherein the oil tank defines a cavity which receives a source of oil which is supplied to the diesel engine during operation, and wherein the source of oil is withdrawn from the oil tank, circulated in the diesel engine and returned to the tank, and wherein the oil tank defines a passageway which receives the oil which is being returned to the oil tank and which directs the oil along a path of travel which facilitates the mixing of the oil in the oil tank.

10. A battery charging assembly as claimed in claim 1, and further comprising:
a starting battery having an amount of stored electrical power and which is electrically coupled with the diesel engine;
a starter which is electrically coupled with the starting battery; and
a programmable controller coupled in charge sensing relation relative to the plurality of batteries which are mounted on the locomotive, and in controlling relation relative to the starter, and wherein the programmable controller energizes the starter with the electrical power which is provided by the starting battery when the electrical charge of the plurality of batteries which are mounted on the locomotive decreases below a first value of less than about 65 volts, and further turns off the diesel engine when the electrical charging current provided to the plurality of batteries which are mounted on the locomotive is less than about a second value of 15 Amps.

11. A battery charging assembly as claimed in claim 10, and further comprising:
a DC to DC converter which is electrically coupled with the alternator and which supplies a charging current which is supplied to the starting battery.

12. A battery charging assembly as claimed in claim 10, and wherein the programmable controller is coupled in controlling relation relative to the diesel engine, and wherein the diesel engine has at least two engine speeds, and wherein the programmable controller causes the diesel motor to operate at a first high engine speed when the charging current provided to the plurality of batteries which are mounted on the locomotive is greater than about 30 Amps, and to operate at a second, low engine speed when the electrical charging current provided to the plurality of batteries which are mounted on the locomotive is less than about 30 Amps.

13. A battery charging assembly as claimed in claim 1, and further comprising:
a cooling radiator coupled in fluid flowing relation relative to the diesel engine; and which further radiates heat energy; and
an air movement assembly positioned adjacent to the cooling radiator, and which provides a stream of cooling air to the cooling radiator, and wherein the stream of cooling air is heated by the cooling radiator, and wherein the heated air stream is supplied to the locomotive.

14. A battery charging assembly as claimed in claim 1, and further comprising:
an electrical heater mounted on the locomotive and positioned remotely relative to the battery charging assembly, and wherein the electrical heater is energized by the electrical power output of the battery charging assembly.

15. A battery charging assembly as claimed in claim 1, and wherein the alternator supplies an electrical power output of less than about 74 volts DC to charge the plurality of batteries which are mounted on the locomotive.

16. A battery charging assembly as claimed in claim 1, and wherein the battery charging assembly weighs less than about 1300 pounds, and occupies a space of less than about 35 cubic feet.

17. A battery charging assembly for use on a locomotive, comprising:
an oil tank which is mounted on the locomotive and which has a top surface, and which further encloses a volume of oil;
a diesel engine of less than about 50 horsepower, and which is mounted on the top surface of the oil tank, and which is further coupled in fluid flowing relation relative to the oil tank, and wherein the diesel engine, when actuated, produces a mechanical power output, and is further operable to withdraw oil from oil tank, and return the oil to the oil tank following the circulation of the oil in the diesel engine;
a selectively engageable clutch which is mounted in force receiving relation relative to the mechanical power output of the diesel engine;
an air compressor mounted on the top surface of the oil tank and which mechanically cooperates with the clutch, and wherein the clutch, when engaged, is operable to deliver mechanical energy from the diesel engine to actuate the air compressor, and wherein the air compressor, when actuated, provides a source of compressed air which is delivered to the locomotive;
an alternator, mounted on the oil tank, and which is coupled in force receiving relation relative to the mechanical power output of the diesel engine, and wherein the alternator, when actuated by the diesel engine, provides a DC electrical power output to charge a plurality of batteries which are mounted on the locomotive; and
a programmable controller which is coupled in controlling relation relative to the diesel engine, and the clutch, and which further controls, at least in part, the operation of the alternator and the air compressor.

18. A battery charging assembly as claimed in claim 17, and wherein the plurality of batteries which are mounted on the locomotive provide electrical power to propel the locomotive, and wherein the source of compressed air is utilized by the locomotive for braking and other purposes.

19. A battery charging assembly as claimed in claim 17, and wherein the programmable controller is coupled in electrical charge sensing relation relative to the plurality of batteries which are mounted on the locomotive, and wherein the programmable controller upon sensing a battery charge of a first value of less than about 65 volts starts, and then operates the diesel engine at a first high engine speed, and further, operates the diesel engine at a second slow engine speed when the electrical charging current provided to the plurality of batteries is less than about 30 Amps, and wherein the programmable controller shuts the diesel engine off when the electrical charging current provided to the plurality of batteries which are mounted on the locomotive is less than about 15 Amps.

20. A battery charging assembly as claimed in claim 17, and wherein the locomotive has a source of diesel fuel, and wherein the diesel engine is coupled in fluid flowing relation relative to the source of diesel fuel, and wherein the locomotive has a maintenance interval of at least about 92 days, and wherein the volume of the oil in the oil tank allows operation of the diesel engine for a time period which is at least equal to the maintenance interval of the locomotive.

21. A battery charging assembly as claimed in claim 17, and wherein the volume of the oil enclosed in the oil tank is greater than about 15 gallons, and wherein the oil tank defines an internal cavity which has opposite, first and second ends, and wherein an oil diffusing baffle is mounted in the cavity of the oil tank, and is operable to direct oil which is being returned to the oil tank by the diesel engine along a path of travel so that the returned oil is delivered into the cavity at the first and/or second ends and facilitates the mixing thereof.

22. A battery charging assembly as claimed in claim 17, and further comprising:
a cooling radiator coupled in fluid flowing relation relative to the die sel engine; and
a heater borne by the locomotive, and which is electrically coupled to the DC electrical power output of the battery charging assembly, and which when energized provides a load for the diesel engine.

23. A battery charging assembly as claimed in claim 17, and further comprising:
a cooling radiator coupled in fluid flowing relation relative to the diesel engine and which radiates heat energy which is generated by the operation of the diesel engine; and
a fan positioned proximate to the cooling radiator, and which directs a stream of air into contact with the cooling radiator, and wherein the stream of air is heated following contact with the cooling radiator, and wherein the heated air stream is provided to the locomotive.

24. A battery charging assembly as claimed in claim 17, and wherein the locomotive is a remotely controlled locomotive, and wherein an electrically actuated control assembly is mounted on the locomotive, and is controllably coupled thereto, and wherein the programmable controller is operable to redirect the DC electrical power output which is typically provided by the alternator to the plurality of batteries, to the electrically actuated control assembly, when the plurality of batteries are being utilized to provide electrical power to propel the remotely controlled locomotive, and to further selectively actuate the air compressor to provide the source of compressed air which is utilized by the remotely controlled locomotive for braking, and other purposes following the redirection of the alternator power.

25. A battery charging assembly as claimed in claim 17, and wherein the DC electrical power output of the alternator is less than about 74 volts DC.

26. A battery charging assembly as claimed in claim 17, and further comprising:
a vibration isolating mounting fixture mounted on the locomotive and which positions the oil tank in spaced relation relative to the locomotive.

27. A battery charging assembly as claimed in claim 17, and further comprising:
a starting battery which provides stored electrical power for starting the diesel engine; and
a DC to DC converter which is electrically coupled with the alternator and which provides a charging current for maintaining the electrical charge of the starting battery.

28. A battery charging assembly for use on a locomotive, comprising:
an oil tank defined by a top and bottom surface, and a sidewall which extends between the top and bottom surfaces, and wherein the oil tank is mounted on, and disposed in spaced relation relative to, the locomotive, and wherein the oil tank defines an internal cavity having opposite first and second ends, and which receives and stores a volume of oil which will facilitate the operation of the battery charging assembly for a time period of at least 92 days, and wherein an oil diffusing baffle is positioned within the cavity of the oil tank and is disposed in spaced relation relative to the top surface thereof, and wherein an aperture is formed in the top surface and which facilitates access to the cavity;
a diesel engine of less than about 50 horsepower and which is mounted on the top surface of the oil tank, and which is further coupled in fluid flowing relation relative to the oil tank by way of the aperture which is formed in the top surface, and wherein the diesel engine, when actuated, has a mechanical power output, and further withdraws oil from the oil tank, and then, following circulation in the diesel engine, returns the previously withdrawn oil back into the oil tank and onto the oil diffusing baffle, and wherein the oil diffusing baffle directs the oil along a path of travel and delivers the oil to a location which is near the opposite ends of the cavity to facilitate the mixing of the oil within the cavity;
a fuel line coupled to the diesel engine and having a distal end which is received within a diesel fuel tank, and which is mounted on the locomotive, and which is further positioned remotely relative to the diesel engine, and wherein the diesel engine withdraws a source of diesel fuel from the diesel fuel tank and through the fuel line for consumption;
a starting battery borne by the top surface of the oil tank, and which provides an electrical current;
a starting motor coupled in force transmitting relation relative to the diesel motor and which is selectively energized by the electrical current which is provided by the starting battery, and wherein the starting motor, when energized renders the diesel engine operational;
a cooling radiator coupled in fluid flowing relation relative to the diesel engine, and which cools the diesel motor after the diesel motor has been started;
a selectively engageable clutch which is mounted in force receiving relation relative to the mechanical power output of the diesel engine;
an alternator which is coupled in force receiving relation relative to the mechanical power output of the diesel engine, and wherein the alternator, when actuated, produces an electrical power output of less than about 74 volts DC which is utilized, at least in part, to charge a plurality of batteries which are mounted on, and subsequently utilized by the locomotive, to provide electrical power for propulsion of the locomotive;
a DC to DC converter which is electrically coupled to the DC electrical power output of the alternator, and which provides a charging current for maintaining the electrical charge of the starting battery;
an air compressor borne by the top surface of the oil tank and which is disposed in selective force receiving relation relative to the diesel engine by the clutch, and wherein the air compressor, when actuated, provides a source of compressed air which is delivered to the locomotive and selectively utilized by the locomotive for braking and other purposes; and
a programmable controller which is coupled in electrical charge sensing relation relative to the plurality of batteries which are mounted on the locomotive, and further disposed in controlling relation relative to the diesel engine, the starting motor for the diesel motor, the alternator, the air compressor and the selectively engageable clutch.

29. A battery charging assembly as claimed in claim 28, and wherein the fuel line has a first end which is coupled to the diesel engine, and an opposite second end, and wherein a fuel passageway is defined between the first and second ends, and wherein the second end of the fuel line is received in the remotely positioned diesel fuel tank, and wherein the distal end of the fuel line is defined by a sidewall which has a plurality of apertures formed therein.

30. A battery charging assembly as claimed in claim 28, and wherein a plurality of vibration isolating mounting fixtures are mounted on the locomotive, and which position the oil tank in spaced relation relative thereto.

31. A battery charging assembly as claimed in claim 28, and wherein the programmable controller upon sensing an electrical charge of less than about 65 volts for the plurality of batteries, causes the starting motor to become energized by the starting battery and which starts the diesel engine, and wherein the diesel engine, once started causes the alternator to deliver the DC electrical power output to increase the electrical charge for the plurality of batteries, and further upon sensing an electrical charging current provided to the plurality of batteries of less than about 15 Amps is operable to stop the delivery of the DC electrical power output of the alternator to the plurality of batteries.

32. A battery charging assembly as claimed in claim 28, and further comprising:
an electrically actuated heater which is borne by the locomotive, and which is selectively electrically coupled with the DC electrical power output of the diesel engine.

33. A battery charging assembly as claimed in claim 32, and wherein the DC electrical power output is provided to the heater for purposes of generating heat which is needed by the locomotive.

34. A battery charging assembly as claimed in claim 32, and wherein the DC electrical power output is provided to the heater to increase the electrical load of the alternator and improve the performance of the diesel engine.

35. A battery charging assembly as claimed in claim 28, and wherein the programmable controller is operable to control the speed of operation of the diesel motor based, at least in part, upon the electrical charge of the plurality of batteries as sensed by the programmable controller.

36. A battery charging assembly as claimed in claim 28, and wherein the locomotive is a remotely controllable locomotive, and wherein an electrically actuated control assembly is mounted on the remotely controllable locomotive and disposed in controlling relation thereto, and wherein the plurality of batteries store electrical power which is utilized in propelling the remotely controlled locomotive, and wherein the programmable controller causes the DC electrical power output of the alternator to be delivered to the electrically actuated control assembly when electrical power is being delivered from the plurality of batteries to propel the remotely controlled locomotive, and wherein the programmable controller substantially deactivates the alternator when the air compressor is selectively activated to provide the source of compressed air which is selectively utilized for braking the remotely controlled locomotive and other purposes.

37. A battery charging assembly as claimed in claim 28 and further comprising:
a fan which is proximally positioned relative to the cooling radiator, and wherein the fan delivers a stream of air to the cooling radiator, and wherein the stream of air is heated by the cooling radiator and is subsequently delivered to the locomotive.
